(19) United States
(12) Patent Application Publication
(10) Pub. No.: US 2015/0320073 A1
(43) Pub. Date: Nov. 12, 2015

(54) CHOCOLATE COMPRISING A TRANSESTERIFIED SHEA OLEIN FRACTION

(71) Applicants: Rasmus Leth MILLER, Viby J (DK); Morten Daugaard ANDERSEN, Aarhus C (DK)

(72) Inventors: Rasmus Leth MILLER, Viby J (DK); Morten Daugaard ANDERSEN, Aarhus C (DK)

(21) Appl. No.: 14/426,709

(22) PCT Filed: Sep. 7, 2012
(86) PCT No.: PCT/DK2012/050335

§ 371 Date: Jun. 19, 2015

(51) Int. Cl. A23G 1/38

(52) U.S. Cl. CPC A23G 1/38; A23V 2002/00

(57) ABSTRACT

The invention relates to a chocolate (CHO) comprising:
a cocoa butter equivalent (CBE) being a mixture comprising a palm oil mid fraction (PMF) and a transesterified shea olein fraction (TSO);
sugar (SUG); and
one or more of the ingredients (ING) cocoa butter, cocoa mass, cocoa powder, milk fat, milk powder, vanilla, and lechitin,
   wherein said cocoa butter equivalent (CBE) has a solid fat content given by 62-81% at 20° C., 55-70% at 25° C., 34-56% at 30° C., and 0-12% at 35° C.,
   wherein the content of StOSt (where St=stearic acid and O=oleic acid) triglycerides of the cocoa butter equivalent (CBE) is at least 18% by weight, and
   wherein the content of SUU (where S=saturated, U=unsaturated) triglycerides of the cocoa butter equivalent (CBE) is less than 8% by weight.

### FIELD OF THE INVENTION

The invention relates to a process according to claim 1.

### BACKGROUND OF THE INVENTION

The invention relates to chocolate. Several problems may exist in relation to such a chocolate and the process for producing it. Therefore, it is an object of the invention to provide a chocolate that can be produced in a cost-effective and efficient way.

### SUMMARY OF THE INVENTION

The invention relates to a chocolate comprising
a cocoa butter equivalent being a mixture comprising a palm oil mid fraction and a transesterified shea olein fraction,
sugar, and
one or more of the ingredients cocoa butter, cocoa mass, cocoa powder, milk fat, milk powder, vanilla, and lechitin,
   wherein said cocoa butter equivalent has a solid fat content given by 62-81% at 20° C., 55-70% at 25° C., 34-56% at 30° C., and 0-12% at 35° C.,
   wherein the content of StOSt (where St=stearic acid and O=oleic acid) triglycerides of the cocoa butter equivalent is at least 18% by weight, and
   wherein the content of SUU (where S=saturated, U=unsaturated) triglycerides of the cocoa butter equivalent is less than 8% by weight.

An advantage of the invention is that a chocolate product can be obtained, which meets certain specific requirements to the solid fat content at different temperatures. This is obtained by using a transesterification process to produce a transesterified shea olein fraction for the cocoa butter equivalent, whereby a pure and well-defined chocolate product may be obtained. Furthermore, the transesterification process provides a selective and effective process for conversion of a low-value shea olein fraction into valuable transesterified shea olein fraction, especially when an enzymatic transesterification is used, which may have a very high conversion specificity.

Also, by means of the transesterified shea olein, a more consistent and predictable solid fat content of the cocoa butter equivalent may be provided. Thereby, the cocoa butter equivalent and therefore the chocolate may be of a more consistent quality, which may lower the need for evaluation or quality testing, such as random testing of cocoa butter equivalent or chocolate products.

One of many advantageous characteristics of a chocolate according to the invention may include increased hardness, increased bloom resistance, decreased trans-fat content, decreased viscosity build-up of the melted chocolate, faster mould-slip time in the production, etc. These advantages may at least partly be established due to an increased content of StOSt triglycerides in the cocoa butter equivalent, which may be established by means of a transesterification. This cocoa butter equivalent having the increased StOSt-content may be obtained by means of a transesterification, i.e. by transesterifying a shea olein fraction to obtain a transesterified stearin fraction with an increased content of StOSt and mixing this transesterified stearin fraction with a palm oil mid fraction. Thereby, the increased StOSt-content and in particular the resulting increased hardness and bloom resistance of a chocolate may be obtained by means of transesterification.

One advantage of the above embodiment is that by using a cocoa butter equivalent, which may be made from a palm oil mid fraction and a stearin fraction prepared by transesterification, for making chocolate, the characteristics of the chocolate may be controlled in the transesterification process. This controllable transesterification process for making the cocoa butter equivalent provides the possibility for tailoring the characteristics of the final chocolate product on one hand, but on the other hand also or alternatively to compensate for variations in the starting point ingredients, which may vary in composition and/or characteristics from year to year and depending on the season or quality. Therefore, by producing a chocolate by means of a transesterification process, a wide range of possibilities is available for obtaining an advantageous and/or specific chocolate product even while decreasing the dependency for a specific quality, chemical composition, or other characteristics of the starting point ingredients.

The tailored characteristics of a chocolate according to the invention may include e.g. increased hardness, increased bloom resistance, decreased trans-fat content, decreased viscosity build-up of the melted chocolate, faster mould-slip time in the production, etc. However, it should be noted that opposite characteristics may also be obtained, and may even be desirable in some products, such as e.g. decreased hardness. However, by means of the transesterification it may be possible to tune these characteristics to a specific set-point depending on the requirements of the final chocolate product. A particular advantage is that such characteristics may be obtained while maintaining an advantageous or unchanged melting profile of the cocoa butter equivalent. Thereby advantages, which include economically beneficial advantages, such as e.g. improved bloom resistance and therefore longer shelf lifetime of the chocolate, and other advantages, which may not be visible to the consumer, may be obtained without devaluating the familiar melting profile, which is characteristic of chocolates enjoyed by the consumer.

Furthermore, an advantage of being able to compensate for variations in input quality is achieved. This variation of input quality may e.g. be variations in the quality of shea nuts and their potential for making cocoa butter equivalent. Such variations may e.g. be due to seasonal change of shea nut harvest, regional harvest failure, origin of the shea nuts, etc. However, by using a transesterification process to obtain a cocoa butter equivalent and a chocolate based thereon, the effect of such variations on the final chocolate product may be obliterated or at least diminished.

Furthermore, an advantage of the invention may be that an increased melting point of the cocoa butter equivalent may be obtained by the transesterification. Thereby lower melting points of other fats in the chocolate may be compensated, thereby obtaining a chocolate comprising low melting point fat, such as milk fat, while maintaining a relatively high melting point. This is a particular advantage for milk chocolate and particularly white chocolate, which typically have large content of milk fat. And the beneficial properties have been obtained in a cost-effective and efficient way by the application of transesterified shea olein.

One of several advantages of an embodiment of the invention is that a process of producing chocolate having certain desired properties can be performed in a relatively efficient manner due to the fact that the enzymatically obtained transesterification and thereby the final content of StOSt can be obtained very selectively and precisely due to the selective properties of enzymes for transesterification purposes. Furthermore, the same process may provide the desired low content of SUU triglycerides.

It should be noted that the StOSt is to be understood as the symmetric 1,3-distearyl-2-oleyl-triglycerides. Furthermore, SUU refer to the asymmetric triglycerides with a saturated fatty acid on position 1 and unsaturated fatty acids on positions 2 and 3, and includes e.g. StOO (1-stearyl-2,3-dioleyl-triglycerides) and POO (1-palmitoyl-2,3-dioleyl-triglycerides). In particular, it should be noted that the transesterification of the shea olein fraction involves a reaction between StOO triglycerides and stearic acid from a stearic acids source, such as stearic acid itself or an ester thereof, such as a methyl ester, to give StOSt and an oleic acid and/or ester thereof. This transesterification reaction is preferably catalyzed by enzymes, preferably 1,3-specific enzymes.

In the present application, claims included, the term chocolate generally designates a product, which resembles chocolate, i.e. chocolate and chocolate equivalents. According to regulations of various countries and regions, different restrains exist of which products that can be marketed as a chocolate. These regulations may put minimum and/or maximum limits on various ingredients, such as sugar, cocoa content, fat content, milk content etc. However, such regulation may not necessarily correspond to the impression of a consumer, who may perceive e.g. a candy bar, which may not be marketed as a chocolate, as being exactly a chocolate bar. Therefore, the term chocolate also covers all products perceived as chocolate by the consumer, such as e.g. chocolate compounds, chocolate coatings, ice cream coating, bakery product coatings, and other coatings.

Furthermore, by starting from a shea olein fraction, which may be unsuitable as a component for making cocoa butter equivalent and chocolate since it has a low melting point, and then using transesterification to increase the melting point of the shea olein fraction by converting StOO and/or OOO triglycerides into StOSt, a large increase in the value of the shea olein fraction as a chocolate component is achieved by means of the transesterification.

It is to be understood that the solid fat content refers to the percentage of the fat that is solid at a given temperature. Therefore, by measuring the solid fat content for several temperatures over a temperature interval, such as for 20° C., 25° C., 30° C., and 35° C., a solid fat content profile may be obtained. Such a solid fat content profile may be taken as a measure for the melting profile.

The solid fat content may be measured using different techniques. One of these techniques involves measuring the density of the fat for different temperatures. As the density changes in the transition between solid and liquid phase, the solid fat content may be extracted from such measurements. Other methods involve differential scanning calorimetry or dilatometry. Yet another method involves measuring by nuclear magnetic resonance (NMR), such as pulsed NMR.

Note that a palm oil mid fraction may be understood as different palm oil products or fractions. Preferably, the PMF should be understood as a hard PMF having an iodine value of 30 to 35, such as 32, 33, or 34. However, in some embodiments, a softer PMF having a higher iodine value of up to e.g. 50 may be usable. In an example embodiment, such as hard PMF may be obtained by fractionation of a palm oil into a hard fraction (stearin fraction) and a soft fraction (olein fraction), then by fractionation of the soft fraction into a second soft fraction (second olein fraction) and a palm oil mid fraction (PMF), and finally by fractionation of the palm oil mid fraction (PMF) into a hard palm oil mid fraction (hard PMF) and a soft palm oil mid fraction (soft PMF).

According to an embodiment of the invention, said cocoa butter equivalent has a solid fat content given by 67-75% at 20° C., 60-66% at 25° C., 43-51% at 30° C., and 0-8% at 35° C.

E.g. the solid fat content may be measured by pNMR (pulsed nuclear magnetic resonance) according to a IUPAC 2.150 (b) method.

According to an embodiment of the invention, said cocoa butter equivalent has a solid fat content given by 67-72% at 20° C., 61-65% at 25° C., 46-51% at 30° C., and 2-7% at 35° C.

E.g. the solid fat content may be measured by pNMR (pulsed nuclear magnetic resonance) according to a IUPAC 2.150 (b) method.

An advantage of the above embodiments is that by producing a cocoa butter equivalent having a solid fat content profile as specified, a cocoa butter equivalent similar or equivalent to natural cocoa butter may be obtained, while, in relation to other embodiments, achieving a high StOSt triglyceride content, a low SUU triglyceride content, and/or several other advantageous characteristics.

According to an embodiment of the invention, the solid fat content is measured by pNMR (pulsed nuclear magnetic resonance) according to a IUPAC 2.150 (b) method.

According to an embodiment of the invention, the solid fat content given at 20° C., 25° C., 30° C., and 35° C. is measured by pNMR (pulsed nuclear magnetic resonance) according to a IUPAC 2.150 (b) method.

Here it should of course be understood that IUPAC refers to the International Union of Pure and Applied Chemistry, and that IUPAC 2.150 (b) method is any method complying with the IUPAC 2.150 (b) method standard. Particularly, this embodiment may be understood in connection with any embodiment concerning the solid fat content at various temperatures. According to alternative embodiments, the solid fat content may be measured by means of other suitable methods.

According to an embodiment of the invention, the solid fat content of the cocoa butter equivalent is unchanged compared to a shea stearin cocoa butter equivalent and/or a cocoa butter.

According to an embodiment of the invention, the solid fat content of the cocoa butter equivalent that is unchanged compared to a shea stearin cocoa butter equivalent and/or a cocoa butter is measured by pNMR (pulsed nuclear magnetic resonance) according to a IUPAC 2.150 (b) method.

According to an embodiment of the invention, said cocoa butter equivalent has a solid fat content profile as a function of temperature similar to a shea stearin based cocoa butter equivalent.

According to an embodiment of the invention, the solid fat content profile as a function of temperature being similar to a shea stearin based cocoa butter equivalent is measured by pNMR (pulsed nuclear magnetic resonance) according to a IUPAC 2.150 (b) method.

By having a similar solid fat content profile as a shea stearin based cocoa butter equivalent or, alternatively, as cocoa butter, the same or a similar sensorial impression is achieved. Matching the solid fat content profile may in one embodiment be considered as having highest priority, e.g. over chemical composition and/or other characteristics. In such embodiments, it may be surprising to achieve a chocolate having advantages such as hardness, anti-bloom characteristics, or other advantages.

According to an example embodiment, the content of SUU triglycerides is less than 3% w/w, such as e.g. 2.7% w/w or 2.6% w/w.

According to an embodiment, the chocolate is produced by mixing and/or blending of the cocoa butter equivalent, the sugar, and more ingredients.

By providing a chocolate or a chocolate-like product, according to the invention, a cost-effective chocolate is achieved. This may e.g. be since the cocoa butter equivalent according to the invention may be used instead of cocoa butter, or may partly replace cocoa butter. While achieving cost-effectiveness of the chocolate, an advantageously faster contracting chocolate is obtained. Such faster contraction during cooling may result in a chocolate made in a mould to slip the mould faster and therefore that the production time of the chocolate is reduced. Even further, by obtaining a chocolate with improved hardness, an advantage is obtained, as such a harder chocolate, such as a chocolate or chocolate-like product, may be perceived to have increased quality when having increased or improved hardness. Therefore, economic advantages of the invention may include reduced expenses for ingredients, cheaper, more effective and/or faster production, and a product with higher quality.

According to an embodiment of the invention, the content of StOSt triglycerides of the cocoa butter equivalent is at least 28% by weight.

By having a high content of StOSt while having a solid fat content profile according to an embodiment of the invention, a number of advantages, such as increased hardness and bloom resistance, may be achieved while at the same time maintaining a melting profile, which resembles natural cocoa butter.

According to an embodiment of the invention, the content of StOSt triglycerides of the cocoa butter equivalent is at least 32% by weight.

By having a high content of StOSt while having a solid fat content profile according to an embodiment of the invention, a number of advantages, such as increased hardness and bloom resistance, may be achieved while at the same time maintaining a melting profile, which resembles natural cocoa butter.

According to an embodiment of the invention, the content of StOSt triglycerides of the cocoa butter equivalent may be measured by means of an HPLC (High-performance liquid chromatography) method. This may be particularly relevant in connection with the above embodiments. Alternatively, the StOSt content may be measured by other suitable means.

According to an embodiment of the invention, the content of SUU triglycerides of the cocoa butter equivalent is less than 6% by weight.

By having a low content of SUU triglycerides while having a solid fat content profile according to an embodiment of the invention, a number of advantages, such as increased bloom resistance, may be achieved while at the same time maintaining a melting profile, which resembles natural cocoa butter.

According to an embodiment of the invention, the content of SUU triglycerides of the cocoa butter equivalent is less than 4% by weight.

By having a low content of SUU triglycerides while having a solid fat content profile according to an embodiment of the invention, a number of advantages, such as increased bloom resistance, may be achieved while at the same time maintaining a melting profile, which resembles natural cocoa butter.

An advantage of several of the above embodiments is that a chocolate comprising cocoa butter equivalent may be produced where the solid fat content is maintained within specific limits while achieving a high content of StOSt triglycerides, which contribute positively to a high melting point, and at the same time achieving a low content of SUU triglycerides, which contributes negatively to high melting point.

When producing a chocolate and a cocoa butter equivalent for that purpose, the production of the cocoa butter equivalent may be controlled in relation to a number of different desired characteristics or chemical content, e.g. of triglycerides, or in relation to other desired aspects of the cocoa butter equivalent or of the chocolate. However, by producing the cocoa butter equivalent according to a specific range of solid fat content for specific temperatures and therefore obtaining a cocoa butter equivalent with a desired melting profile by means of a transesterification process, a high content of StOSt has been realized. The content of StOSt may originate from different sources, such as partly from a shea stearin fraction mixed with the transesterified shea olein fraction and the palm oil mid fraction, however, it is preferred that fraction of the StOSt originates from the transesterified shea olein fraction. Also, by using transesterification with a stearic acid source and in particular an enzymatic transesterification, preferably by means of 1,3-specific enzymes, the high content of StOSt can be established. One advantage of using an enzymatic transesterification is that the conversion degree can be controlled in a relatively simple manner e.g. by the time, which the shea olein is in contact with the enzymes and a source for stearic acid.

According to an embodiment of the invention, the content of SUU triglycerides of the cocoa butter equivalent may be measured by means of an HPLC (High-performance liquid chromatography) method. This may be particularly relevant in connection with the above embodiments. Alternatively, the SUU content may be measured by other suitable means.

According to an embodiment of the invention, said chocolate has improved anti-bloom properties.

By having improved anti-bloom properties the chocolate may be stored longer, i.e. the shelf lifetime is extended. Also, since chocolate and chocolate-like confectionary may often be especially vulnerable to bloom at elevated temperatures, the chocolate according to the above embodiment may be particularly advantageous for warmer climates or for storing at a lower temperature.

In one embodiment, the improved anti-bloom properties are especially dominant when said chocolate is a tablet or solid bar product, i.e. not e.g. a filled chocolate. Also, in one embodiment, the anti-bloom properties are dominant when said chocolate is used in connection with a biscuit or biscuit-like bakery product, such as a coated biscuit.

According to an embodiment of the invention, said chocolate has lower trans-fat content.

An advantage of the above embodiment is that a chocolate with a lower trans-fat content is healthier. As trans-fat is known to increase the cholesterol levels and cause the risk of coronary heart disease, it is a distinct advantage to provide a chocolate with a low or lower content of trans-fat. The content of the trans-fat may in an example embodiment be e.g. lower than 0.5 percent by weight, such as lower than 0.4 percent by weight, such as lower than 0.3 percent by weight, such as lower than 0.2 percent by weight, such as lower than 0.15 percent by weight, such as lower than 0.1 percent by weight.

According to an embodiment of the invention, said chocolate has improved melting profiles.

An advantage of the above embodiment is that the melting profile is critical to the taste sensation of the chocolate. For example the melting profile could preferably be such that the chocolate does not melt when hold in the hand, but melts in the mouth, i.e. it melts at body temperature.

Furthermore, studies have shown that the melting peak positions for the cocoa butter equivalent used in the chocolate of the invention are increased by 0.6-0.7° C. during the first 14 days of storage. Within theory this is a clear indication that the polymorphic purification may have taken place in the triglyceride system, where the remnants of beta′ (form IV) crystals transform to beta 2 (form V) crystals. Thereby, the chocolate comprising the cocoa butter equivalent may be substantially less vulnerable to bloom. The beneficial properties have been obtained in a cost-effective and efficient way by the application of transesterified shea olein. However, the embodiments of the invention are not bound by accuracy of theories.

According to an embodiment of the invention, said chocolate has slower viscosity build up.

Advantages of the above embodiment comprise that a melted chocolate may be pumpable, and therefore that pipeline pumping, depositing, enrobing etc. is no problem. As the viscosity build up is slower according to the above embodiment, the pumpability of the melted chocolate may be increased or prolonged.

According to an embodiment of the invention, said chocolate has improved sensorial attribute scores.

Sensorial attribute scores may comprise one or more of tough, tallow, dry, brittle, hard, snap, totally meltet, cooling, melt rapidity, early meltstart, and thick. In one embodiment, particularly the sensorial attribute scores hard, snap, cooling, melt rapidity, and early meltstart are of particular interest.

By producing a chocolate comprising a cocoa butter equivalent based partly on a shea olein fraction, an improved chocolate having at least one improved characteristic is thereby obtained. Such chocolate according to the above embodiment may be advantageous in several ways. First, by comprising a vegetable fat originating from a shea olein fraction, the production costs associated with said chocolate may be lower than those of a chocolate containing only vegetable fat, which is cocoa butter, or of a chocolate containing only vegetable fat which is cocoa butter or illipe fat, palm-oil, sal fat, shea fat, kokum fat, or mango kernel fat, which may optionally be refined, purified, and/or fractionated. It is to be understood that by having improved sensorial attribute scores, may be understood that several of the sensorial attribute scores are better, such as two, three, four, five or more sensorial attribute scores. However, it may also be understood that only a single of the sensorial attribute scores are better, or that the sensorial attribute scores as a whole are better.

According to an embodiment of the invention, said chocolate has similar anti-bloom properties.

According to an embodiment of the invention, said chocolate has similar trans-fat content.

According to an embodiment of the invention, said chocolate has similar tempering settings.

An advantage of the above embodiment is that only minor adjustments are needed to switch between tempering of chocolate based on cocoa butter and/or conventional shea stearin cocoa butter equivalent.

According to an embodiment of the invention, said chocolate has similar melting profiles.

According to an embodiment of the invention, said chocolate has similar viscosity evolution.

According to an embodiment of the invention, said chocolate has similar attribute scores.

By having similar properties, according to the above embodiment, the chocolate is made partly from a shea olein fraction, while still having excellent properties, i.e. without degradation in the product properties, such as the properties stated above.

An advantage of the above embodiment may be that by having similar tempering properties, the same tempering facility for chocolate may be used to temper a chocolate according to any embodiment of the invention, but also for other chocolates, such as chocolates comprising as cocoa butter equivalent based on a shea stearin fraction obtained by fractionation of shea butter and a palm oil mid fraction. Furthermore, such a tempering facility may also in some embodiments be used for tempering chocolates without cocoa butter equivalent, i.e. chocolate based on natural cocoa butter.

According to an embodiment, it is to be understood that all characteristics, attributes etc. mentioned above as improved or similar may be understood as being compared to a conventional chocolate, such as a chocolate or chocolate-like products. The fat content of such conventional chocolate may be based on cocoa butter, and/or alternatively on a cocoa butter equivalent fat, such as cocoa butter equivalent based on palm oil mid fraction and a shea stearin fraction; an example of such cocoa butter equivalent may be the Illexao SC series, such as the Illexao SC 70.

According to an embodiment of the invention, said sensorial attributes comprise at least one of hardness, snap, totally melted, cooling, melt rapidity, early meltstart, thick, tough, tallow, dry, and brittle.

According to the above embodiment, at least one of the sensorial attributes as stated above is similar or better when compared to the characteristics of regular chocolate. By better is meant that for the specific sensorial attribute, the score for the chocolate according to the above embodiment it higher for positive attributes, such as hard, snap, cooling, melt rapidity, and early meltstart, while the score is less for negative properties, such as tough, tallow, and dry.

According to an embodiment of the invention, said chocolate scores at least 5% higher in a penetrating needle texture analysis.

The penetrating needle analysis may according to an example embodiment be carried out by penetrating 3 millimeters into the chocolate. This may be done at various temperatures, such as e.g. 20° C., 25° C., or 27° C. The penetrating needle texture analysis score may vary at these temperatures, and the 5% may be understood as being at one particular temperature or as an average at different temperatures. According to alternative embodiments, the score may be at least 2, 3, 4, 8, 10, 15, 20, 25, 30, 40, 50, 60, 70, or 80 percent higher.

According to an example embodiment of the invention, the penetrating needle texture analysis is performed by a Texture Analyzer TA-XT2i apparatus. The probe used for the penetrating needle texture analysis may e.g. be a Needle P2. Furthermore, the penetrating needle may preferably penetrate into a depth of 3 mm. I.e. according to the example embodiment, the penetrating needle texture analysis is performed by penetrating a Needle P2 of a Texture Analyzer TA-XT2i apparatus into a penetration depth of 3 mm into the chocolate.

According to alternative embodiments, other suitable methods may be used to determine the texture.

According to an embodiment of the invention, said chocolate has improved characteristics compared to a chocolate comprising cocoa butter equivalent based on palm oil mid fraction and a shea stearin fraction.

According to the above embodiment, the chocolate has improved characteristics compared to a chocolate based on conventional shea stearin cocoa butter equivalent. It is to be understood that the chocolate according to the above embodiment may comprise such conventional shea stearin cocoa butter equivalent and/or cocoa butter along with the cocoa butter equivalent according to the above embodiment.

According to an embodiment of the invention, said chocolate has improved characteristics compared to a chocolate comprising cocoa butter.

According to the above embodiment, the chocolate has improved characteristics compared to a chocolate based on cocoa butter. It is to be understood that the chocolate according to the above embodiment may comprise such conventional shea stearin cocoa butter equivalent and/or cocoa butter along with the cocoa butter equivalent according to the above embodiment.

According to an embodiment of the invention, said chocolate comprises between 5 and 80% by weight of cocoa mass, such as between 5 and 70% by weight of cocoa mass, such as between 5 and 60% by weight of cocoa mass, such as between 5 and 50% by weight of cocoa mass, such as between 10 and 50% by weight of cocoa mass, such as between 10 and 20% by weight of cocoa mass, or such as between 30 and 50% by weight of cocoa mass, such as between 35 and 45% by weight of cocoa mass.

In one embodiment, the chocolate may comprise at least 2.5, 5, 7.5, 10, 12.5, 15, 17.5, 20, 22.5, 25, 27.5, 30, 35, 40, 45, 50, 55, 60, 65, 70, 75, 80, 85, 90, or 95% by weight of cocoa mass, such as 2.5, 5, 7.5, 10, 12.5, 15, 17.5, 20, 22.5, 25, 27.5, 30, 35, 40, 45, 50, 55, 60, 65, 70, 75, 80, 85, 90, or 95% by weight of cocoa mass, said cocoa mass comprising cocoa powder and cocoa butter. According to one embodiment liquid cocoa mass may be used, which may be referred to as cocoa liquor.

According to an embodiment of the invention, said chocolate comprises between 2 and 50% by weight of cocoa powder, such as between 2 and 40% by weight of cocoa powder, such as between 2 and 30% by weight of cocoa powder, such as between 5 and 20% by weight of cocoa powder, such as between 10 and 20% by weight of cocoa powder, or such as between 5 and 10% by weight of cocoa powder.

The chocolate may in example embodiment comprise 2.5, 5, 7.5, 10, 12.5, 15, 17.5, 20, 22.5, 25, 27.5, or 30% by weight of cocoa powder. Cocoa powder is to be understood as a low fat powder component extracted from cocoa beans other than cocoa butter.

According to an embodiment of the invention, said chocolate comprises between 1 and 50% by weight of cocoa butter, such as between 5 and 40% by weight of cocoa butter, such as between 10 and 30% by weight of cocoa butter, such as between 15 and 25% by weight of cocoa butter, such as between 15 and 20% by weight of cocoa butter.

Alternatively, the chocolate may comprise at least 2.5, 5, 7.5, 10, 12.5, 17.5, 20, 22.5, 25, 27.5, 30, 35, 40, 45, 50, 55, 60, 65, 70, 75, 80, 85, 90, or 95% by weight cocoa butter and/or no more than 2.5, 5, 7.5, 10, 12.5, 15, 17.5, 20, 22.5, 25, 27.5, 30, 35, 40, 45, 50, 55, 60, 65, 70, 75, 80, 85, 90, or 95% by weight of cocoa butter. Also, the chocolate may be cocoa butter free, when the cocoa butter is completely replaced by cocoa butter equivalent.

According to an embodiment of the invention, the chocolate comprises between 1 and 50% by weight of milk components, such as between 3 and 40% by weight of milk components, such as between 5 and 40% by weight of milk components, such as between 5 and 30% by weight of milk components, such as between 20 and 30% by weight of milk components, such as between 25 and 30% by weight of milk components.

In example embodiments, the chocolate may comprise 2.5, 5, 7.5, 10, 12.5, 15, 17.5, 20, 22.5, 25, 27.5, 30, 32.5, 35, 37.5, or 40 percent by weight of said milk of milk components. Such milk components may be such as milk fat or milk powder, such as skim milk powder or whole milk powder.

According to an embodiment of the invention, said chocolate comprises between 1 and 50% by weight of the cocoa butter equivalent, such as between 5 and 40% by weight of cocoa butter equivalent, such as between 10 and 30% by weight of cocoa butter equivalent, such as between 15 and 25% by weight of cocoa butter equivalent, such as between 15 and 20% by weight of cocoa butter equivalent.

Alternatively, the chocolate may comprise at least 2.5, 5, 7.5, 10, 12.5, 17.5, 20, 22.5, 25, 27.5, 30, 35, 40, 45, 50, 55, 60, 65, 70, 75, 80, 85, 90, or 95% by weight cocoa butter equivalent and/or no more than 2.5, 5, 7.5, 10, 12.5, 15, 17.5, 20, 22.5, 25, 27.5, 30, 35, 40, 45, 50, 55, 60, 65, 70, 75, 80, 85, 90, or 95% by weight of cocoa butter equivalent.

According to an embodiment of the invention, said chocolate contains maximum 5% by weight of the cocoa butter equivalent.

For example, the chocolate may contain 5, 4, 3, 2, or 1% by weight of cocoa butter equivalent. An advantage of the above embodiment may be that the chocolate, at least in some countries, may be labeled as chocolate. Alternatively, the chocolate contains maximum 10, 15, 20, 25, 30, 35, 40, 45, 50, 55, 60, 65, 70, 75, 80, 85, 90, or 95 percent by weight of the cocoa butter equivalent.

According to an embodiment of the invention, said chocolate comprises between 10 and 80% by weight of sugar, such as between 20 and 70% by weight of sugar, such as between 30 and 70% by weight of sugar, such as between 35 and 60% by weight of sugar, such as between 35 and 55% by weight of sugar, preferably between 40 and 50% by weight of sugar.

Alternatively, the chocolate may comprise at least 2.5, 5, 7.5, 10, 12.5, 17.5, 20, 22.5, 25, 27.5, 30, 35, 40, 45, 50, 55, 60, 65, 70, 75, 80, 85, 90, or 95% by weight of sugar and/or no more than 2.5, 5, 7.5, 10, 12.5, 15, 17.5, 20, 22.5, 25, 27.5, 30, 35, 40, 45, 50, 55, 60, 65, 70, 75, 80, 85, 90, or 95% by weight of sugar.

According to an embodiment of the invention, said cocoa butter equivalent comprises between 20 and 65% by weight of said transesterified shea olein fraction, such as between 25 and 60% by weight of said transesterified shea olein fraction.

For example, the cocoa butter equivalent may comprise 40, 45, 50, 51, 52, 53, 54, 55, 56, 57, 58, 59, 60, or 65% percent by weight of said transesterified shea olein fraction. Alternatively, the cocoa butter equivalent may comprise 5, 10, 15, 70, 75, 80, 85, or 90% by weight of said transesterified shea olein fraction.

According to an embodiment of the invention, said transesterified shea olein fraction comprises at least 60% by weight of StOSt (St=stearic acid, O=oleic acid).

For example, the transesterified shea olein fraction may comprise around 65 or 70 percent by weight of StOSt.

According to an embodiment of the invention, said cocoa butter equivalent comprises between 45 and 60 percent by weight of palm oil mid fraction.

Preferably, the cocoa butter equivalent may comprise between 50 and 56 percent by weight of palm oil mid fraction, such as 50, 51, 52, 53, 54, 55, or 56 percent by weight of palm oil mid fraction.

According to an embodiment of the invention, said chocolate is a dark chocolate.

According to an embodiment of the invention, said chocolate is a milk chocolate.

Alternatively, the chocolate may be a sweet chocolate, white chocolate, buttermilk chocolate, skim milk chocolate, mixed dairy product chocolate, semisweet chocolate, plain chocolate, black chocolate, bittersweet chocolate, compound chocolate, couverture chocolate, unsweetened chocolate, bitter chocolate, baking chocolate, cooking chocolate, or other chocolate or chocolate-like products.

According to an embodiment of the invention, said chocolate is a chocolate-like product.

By a chocolate-like product is to be understood a product, which corresponds to chocolate and has similar triglyceride composition, taste, and/or melting profile of the solid fat content as a chocolate product. According to another alternative embodiment, a chocolate-like product may be defined as a product which is perceived as chocolate.

According to an embodiment of the invention, said cocoa butter equivalent is miscible in any proportion with cocoa butter.

In an example embodiment, the cocoa butter equivalent and cocoa butter may be mixed in any ratio without changing the characteristics of cocoa butter substantially.

According to an embodiment of the invention, said cocoa butter equivalent is compatible with the physical properties of cocoa butter, hereunder melting point and crystallization temperatures, melting rate, and need for tempering.

According to an embodiment of the invention, at least 50% by weight of the StOSt triglycerides in the cocoa butter equivalent are obtained by transesterification, such as at least 80% by weight, such as at least 90% by weight, such as at least 95% by weight, such as at least 98% by weight, such as at least 99% by weight.

According to an embodiment of the invention, the StOSt triglycerides comprises StOSt tryglycerides obtained by transesterification.

According to an embodiment of the invention, the content of StOSt triglycerides of the cocoa butter equivalent is between 18 and 80% by weight, such as between 28 and 80% by weight, such as between 32 and 80% by weight, and

wherein the content of SUU triglycerides of the cocoa butter equivalent is between 0.01 and 10% by weight, such as between 0.01 and 8% by weight, such as between 0.01 and 6% by weight, such as between 0.01 and 4% by weight.

According to an embodiment, the content of StOSt triglycerides of the cocoa butter equivalent is between 18 and 70% by weight, such as between 18 and 60% by weight, such as between 18 and 50% by weight, such as between 18 and 40% by weight, such as between 18 and 38% by weight, such as between 18 and 36% by weight. According to another embodiment, the content of StOSt triglycerides of the cocoa butter equivalent is between 28 and 70% by weight, such as between 28 and 60% by weight, such as between 28 and 50% by weight, such as between 28 and 40% by weight, such as between 28 and 38% by weight, such as between 28 and 36% by weight. According to another embodiment, the content of StOSt triglycerides of the cocoa butter equivalent is between 32 and 70% by weight, such as between 32 and 60% by weight, such as between 32 and 50% by weight, such as between 32 and 40% by weight, such as between 32 and 38% by weight, such as between 32 and 36% by weight.

According to a further embodiment, the enzymes are lipase, such as a 1,3-specific lipase. Examples of such 1,3-specific lipases may e.g. be lipases of Rhizopus delemar, Mucor miehei, Aspergillus niger, Rhizopus arrhizus, Rhizopus niveus, Mucor javanicus, Rhizopus javanicus, Rhicomucor miezei, and Rhizopus oxyzae. Other 1,3-specific lipases may also be used.

It should be noted that in the context of various embodiments, a transesterified shea olein fraction may be processed subsequent to a transesterification. Such processing may preferably include a fractionation, so that only a part of an output from the transesterification constitutes the transesterified shea olein fraction, preferably a higher melting point fraction of the output being rich in StOSt triglycerides. Furthermore, it should be noted that by a transesterification may preferably be meant an enzymatic transesterification, as such an enzymatic transesterification may be selective and give a particularly high output of StOSt triglycerides.

The invention furthermore relates to a chocolate comprising
a cocoa butter equivalent being a mixture comprising a palm oil mid fraction and a transesterified shea olein fraction,
sugar, and
one or more of the ingredients cocoa butter, cocoa mass, cocoa powder, milk fat, milk powder, vanilla, and lechitin,
   wherein said cocoa butter equivalent has a solid fat content given by 67-75% at 20° C., 60-66% at 25° C., 43-51% at 30° C., and 0-8% at 35° C., and
   wherein the content of StOSt triglycerides of the cocoa butter equivalent is at least 32% by weight.

According to an embodiment of the invention, the chocolate according to the above embodiment and any other embodiment of the invention is provided.

The invention furthermore relates to a method for producing a chocolate,

wherein said cocoa butter equivalent has a solid fat content given by 62-81% at 20° C., 55-70% at 25° C., 34-56% at 30° C., and 0-12% at 35° C.,
wherein the content of StOSt triglycerides of the cocoa butter equivalent is at least 18% by weight, wherein the StOSt triglycerides comprises StOSt tryglycerides obtained by transesterification,
wherein the content of SUU triglycerides of the cocoa butter equivalent is less than 8% by weight, and
wherein the method comprises the steps of
transesterifying a shea olein fraction to obtain a transesterified shea olein fraction, mixing a palm oil mid fraction and the transesterified shea olein fraction to obtain a cocoa butter equivalent, and
mixing the cocoa butter equivalent with sugar, and one or more of the ingredients cocoa butter, cocoa mass, cocoa powder, milk fat, milk powder, vanilla, and lechitin to obtain the chocolate.

According to an embodiment of the invention, the method comprises conching the chocolate.

According to an embodiment of the invention, the method comprises tempering the chocolate.

According to an embodiment of the invention, the method according to any of the above embodiments of producing a chocolate according to any of the above embodiments is provided.

The invention furthermore relates to the use of a transesterified shea olein fraction as an ingredient in a chocolate. Preferably, such use of the transesterified shea olein fraction may be in a cocoa butter equivalent, which is then used in a chocolate.

According to an embodiment of the invention, a chocolate according to any embodiment of the invention and produced by the method of any embodiment of the invention is provided.

The invention furthermore relates to a chocolate comprising
a cocoa butter equivalent, and
sugar,
   said cocoa butter equivalent comprising
a stearin fraction and
a palm oil mid fraction,
   wherein said stearin fraction being obtained from a shea olein fraction by an enzymatic transesterification process.

The invention furthermore relates to a method of producing a chocolate, said method comprising the steps of
obtaining a stearin fraction from a shea olein fraction by an enzymatic transesterification process,
mixing the stearin fraction with a palm oil mid fraction to produce a cocoa butter equivalent, and
mixing said cocoa butter equivalent with sugar to obtain a chocolate.

By providing the above method, the chocolate according to the invention with the distinct advantages as described may be obtained.

According to an embodiment of the invention, a chocolate according to any embodiment of the invention and produced by the method of the above embodiment is provided.

### FIGURES

The invention will now be described with reference to the drawings, where

FIG. 1 illustrates a method and system for producing a chocolate according to an embodiment of the invention, and

FIG. 2 illustrates a method and system for producing a chocolate according to an embodiment of the invention.

### DETAILED DESCRIPTION

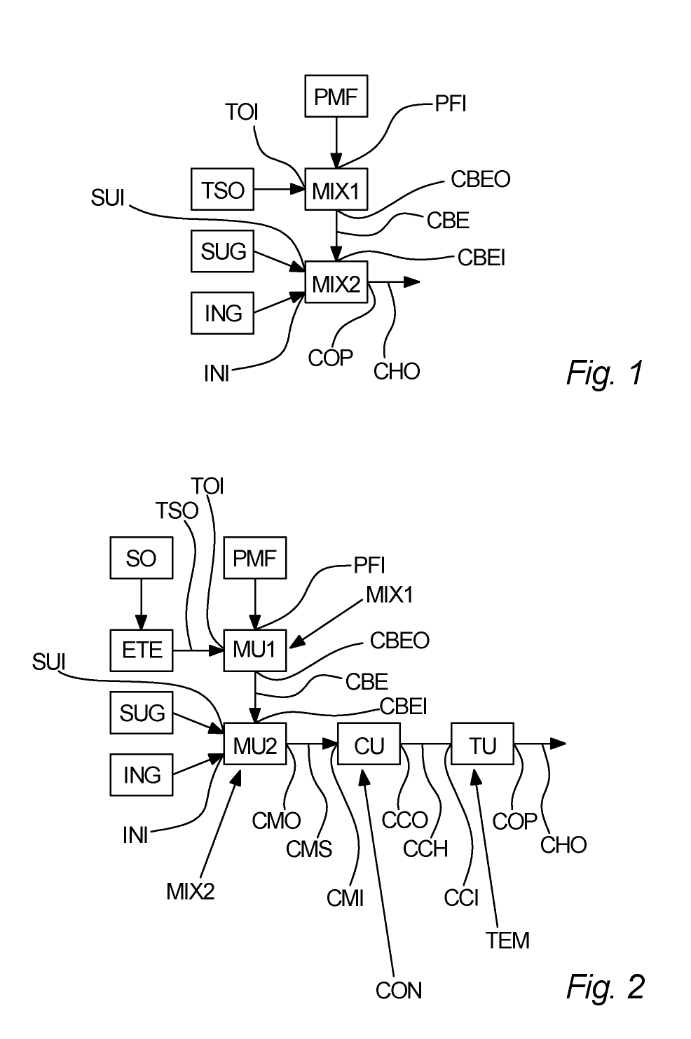

Referring to FIG. 1, an embodiment of the invention is described. According to the embodiment, a chocolate CHO is produced from a cocoa butter equivalent CBE, sugar SUG, and an amount of other ingredients ING, comprising cocoa butter, cocoa mass, cocoa powder, milk fat, milk powder, vanilla, and lechitin. Also, the cocoa butter equivalent is produced from a palm oil mid fraction PMF, which is mixed with a transesterified shea olein fraction TSO to give the cocoa butter equivalent CBE. This mixing of the cocoa butter equivalent may e.g. be in a 1:1 ratio between the palm oil mid fraction PMF and the transesterified shea olein fraction TSO. Alternatively, the mixing ratio is such that the cocoa butter equivalent CBE comprises between 30 and 60% by weight of the transesterified shea olein fraction TSO, preferably between 40 and 50% by weight, such as e.g. 45% by weight, while the rest of the cocoa butter equivalent CBE is made up of palm oil mid fraction PMF. However, the cocoa butter equivalent may comprise further components or additives, the transesterified shea olein fraction TSO together with the palm oil mid fraction PMF preferably making up at least 70% by weight of the cocoa butter equivalent CBE, even more preferably at least 80% by weight of the cocoa butter equivalent CBE, even more preferably at least 90% by weight of the cocoa butter equivalent CBE, even more preferably at least 95% by weight of the cocoa butter equivalent CBE, even more preferably at least 99% by weight of the cocoa butter equivalent CBE. I.e. the content of shea stearin extracted from shea fat by fractionation and/or other processes, excluding transesterification, is preferably present only in small amounts or is not present at all in the cocoa butter equivalent CBE, such as present up to 30% by weight, or up to 1% by weight, or other limits as stated by the above minimum limits for the transesterified shea olein fraction TSO together with the palm oil mid fraction PMF.

Referring to FIG. 2, another embodiment of the invention is illustrated. According to this embodiment, further steps of processing of the chocolate are shown illustrating a method of producing a chocolate, and the system for making the chocolate. First a shea olein fraction SO is transesterified in an enzymatic transesterification process ETE, giving a transesterified shea olein fraction TSO. The transesterified shea olein fraction TSO is fed into a first mixing unit MX1 through a transesterified shea olein fraction input. In a first mixing step MIX1 the transesterified shea olein fraction TSO is mixed in the first mixing unit MX1 with a palm oil mid fraction PMF, which is fed into the first mixing unit MX1 through a palm oil mid fraction input PFI. From the first mixing unit MX1 is obtained a cocoa butter equivalent CBEO through a cocoa butter equivalent output CBEO. The cocoa butter equivalent CBE is then fed into a second mixing unit MX2 through a cocoa butter equivalent input CBEI. Also, sugar SUG is fed into the second mixing unit MX2 through a sugar input SUI and other ingredients ING comprising at least one of cocoa butter, cocoa mass, cocoa powder, milk fat, milk powder, vanilla, and lechitin are fed into the second mixing unit MX2 through an ingredients input INT. It is to be understood that one or more of the ingredients ING may be fed into the second mixing unit MX2 through a common input or through separate inputs. Then a second mixing step MIX2 is performed in the second mixing unit MX2, where the cocoa butter equivalent CBE, the sugar SUG, and the one or more ingredients ING are mixed or blended. From the second mixing unit MX2 is then obtained a chocolate mass CMS through a chocolate mass output CMO. The chocolate mass CMS is then inputted to a conching unit CU, in which a conching process CON is performed. Such a conching process CON may comprise a penultimate process where the chocolate mass CMS is grinded and particles, such as cocoa and sugar particles, are grinded into small particles, which cannot be felt when eating the finished chocolate product. Thereby a more even texture of the final chocolate product is obtained. After the conching CON, a conched chocolate mass CCH is obtained from a conched chocolate mass output CCO, and the conched chocolate mass CCH is fed into a tempering unit TU through a conched chocolate mass input CCI. The conched chocolate mass CCH is then in a tempering step TEM performed in the tempering unit TU tempered into a chocolate CHO, which finally may be obtained from a chocholate output CHO. In the tempering step TEM, the conched chocolate mass CCH is treated with a number of temperature treatments in order to promote transformation of crystalline structure in the conched chocolate mass CCH into the advantageous crystalline form V, also known as beta2-3. Furthermore, the tempering step TEM prevents formation of too large crystals in the chocolate CHO.

### Example 1-3

Example 1-2 are manufactured with the composition illustrated in table I, according to FIG. 1 and with the exception that the transesterified shea olein TSO is substituted with a shea stearin obtained from shea nuts by a conventional separation process. Example 3 is manufactured according to the embodiment, which is illustrated on FIG. 1.

TABLE I

| | Ex 1 | Ex 2 | Ex 3 |
|---|---|---|---|
| Cocoa powder | 15 | 15 | 15 |
| Sugar | 50 | 50 | 50 |
| Skimmilk powder | 5 | 5 | 5 |
| CBE-A | 30 | 30 | 0 |
| CBE-B | 0 | 0 | 30 |

In the above table I, the numbers signify the content in percent by weight in the chocolate products of Example 1-3.

TABLE II

| | Ex 1 | Ex 2 | Ex 3 |
|---|---|---|---|
| SFC 20° C. | 68 | 69 | 70 |
| SFC 25° C. | 62 | 62 | 62.4 |
| SFC 30° C. | 47 | 48 | 50.2 |
| SFC 35° C. | 3 | 4 | 5.1 |
| StOSt | 30.8 | 31 | 34.2 |
| SUU | 5.1 | 5.3 | 2.7 |

In the above table II, the SFC numbers signify the solid fat content (SFC) in percent of the product at the given temperature. To measure these SFC numbers a method, which complies with the IUPAC 2.150 parallel method, has been used. The StOSt and SUU numbers signify the content in percent by weight of the given triglyceride, which has been measured by a high-performance liquid chromatography (HPLC) method.

Explanations of the used abbreviations are given below.

SUU: Asymmetric triglycerides comprising one saturated and two unsaturated fatty acids.
StOSt: Symmetrical 1,3-distearyl-2-oleyl-triglyceride.
SFC: Solid fat content measured by NMR-spectroscopy.
CBE-A: Cocoa butter equivalent obtained from 54 w/w of a palm oil mid fraction and 46% w/w of a shea stearin obtained from shea nuts by a conventional separation process.
CBE-B: Cocoa butter equivalent obtained from 54% w/w of a palm oil mid fraction and 46% w/w of a transesterified shea olein TSO.

The desired SFC profile as illustrated in table II has been obtained by means of a cocoa butter equivalent CBE-B, which comprises an enzymatically transesterified shea olein fraction. Moreover, a high content of StOSt triglycerides and a low content of SUU triglycerides in the cocoa butter equivalent CBE-B have been achieved by means of a transesterification process.

### REFERENCE NUMERALS

PMF. Palm oil mid fraction
PFI. Palm oil mid fraction input
SO. Shea olein fraction
ETE. Enzymatic transesterification
TSO. Transesterified shea olein fraction
TOI. Transesterified shea olein fraction input
MIX1. First mixing step
CBEO. Cocoa butter equivalent output
CBE. Cocoa butter equivalent
CBEI. Cocoa butter equivalent input
SUG. Sugar
SUI. Sugar input
ING. Ingredient
INI. Ingredient input
MIX2. Second mixing step
COP. Chocolate output
CHO. Chocolate
MU1. First mixing unit
MU2. Second mixing unit
CMO. Chocolate mass output
CMS. Chocolate mass
CMI. Chocolate mass input
CON. Conching
CU. Conching unit
CCO. Conched chocolate mass output
CCH. Conched chocolate mass
CCI. Conched chocolate mass input
TEM. Tempering
TU. Tempering unit

1. A chocolate (CHO) comprising:
a cocoa butter equivalent (CBE) being a mixture comprising a palm oil mid fraction (PMF) and a transesterified shea olein fraction (TSO);
sugar (SUG); and
one or more of the ingredients (ING) consisting of cocoa butter, cocoa mass, cocoa powder, milk fat, milk powder, vanilla, and lechitin,
wherein the cocoa butter equivalent (CBE) has a solid fat content given by 62-81% at 20° C., 55-70% at 25° C., 34-56% at 30° C., and 0-12% at 35° C.,
wherein the content of StOSt (where St=stearic acid and O=oleic acid) triglycerides of the cocoa butter equivalent (CBE) is at least 18% by weight, and
wherein the content of SUU (where S=saturated, U=unsaturated) triglycerides of the cocoa butter equivalent (CBE) is less than 8% by weight.

2. A chocolate (CHO) according to claim 1, wherein the cocoa butter equivalent (CBE) has a solid fat content given by 67-75% at 20° C., 60-66% at 25° C., 43-51% at 30° C., and 0-8% at 35° C.

3. (canceled)

4. A chocolate (CHO) according to claim 1, wherein the solid fat content of the cocoa butter equivalent (CBE) is unchanged compared to a shea stearin cocoa butter equivalent or a cocoa butter.

5. A chocolate (CHO) according to claim 1, wherein the cocoa butter equivalent (CBE) has a solid fat content profile as a function of temperature similar to a shea stearin based cocoa butter equivalent.

6. A chocolate (CHO) according to claim 1, wherein the content of StOSt triglycerides of the cocoa butter equivalent (CBE) is at least 28% by weight.

7-11. (canceled)

12. A chocolate (CHO) according to claim 1, wherein the chocolate (CHO) has improved melting profiles.

13. A chocolate (CHO) according to claim 1, wherein the chocolate (CHO) has a slower viscosity build up.

14. A chocolate (CHO) according to claim 1, wherein the chocolate (CHO) has improved sensorial attribute scores.

15-20. (canceled)

21. A chocolate (CHO) according to claim 1, wherein the sensorial attributes comprise at least one of hardness, snap, totally melted, cooling, melt rapidity, early meltstart, thick, tough, tallow, dry, and brittle.

22. (canceled)

23. A chocolate (CHO) according to claim 1, wherein the chocolate (CHO) has improved characteristics compared to a chocolate comprising cocoa butter equivalent based on palm oil raid fraction (PMF) and a shea stearin fraction.

24. A chocolate (CHO) according to claim 1, wherein the chocolate (CHO) has improved characteristics compared to a chocolate comprising cocoa butter.

25. A chocolate (CHO) according to claim 1, wherein the chocolate (CHO) comprises between 5 and 80% by weight of cocoa mass.

26. A chocolate (CHO) according to claim 1, wherein the chocolate (CHO) comprises between 2 and 50% by weight of cocoa powder.

27. A chocolate (CHO) according to claim 1, wherein the chocolate (CHO) comprises between 1 and 50% by weight of cocoa butter.

28. A chocolate (CHO) according to claim 1, wherein the chocolate (CHO) comprises between 1 and 50% by weight of milk components.

29. A chocolate (CHO) according to claim 1, wherein the chocolate (CHO) comprises between 1 and 50% by weight of the cocoa butter equivalent (CBE).

30. A chocolate (CHO) according to claim 1, wherein the chocolate (CHO) contains a maximum of 5% by weight of the cocoa butter equivalent (CBE).

31. (canceled)

32. A chocolate (CHO) according to claim 1, wherein the cocoa butter equivalent (CBE) comprises at least 40% by weight of the transesterified shea olein fraction (TSO).

33. (canceled)

34. A chocolate (CHO) according to claim 1, wherein the cocoa butter equivalent (CBE) comprises between 45 and 60 percent by weight of palm oil mid fraction (PMF).

35. A chocolate (CHO) according to claim 1, wherein the chocolate (CHO) is a dark chocolate.

36. A chocolate (CHO) according to claim 1, wherein the chocolate (CHO) is a milk chocolate.

37. A chocolate (CHO) according to claim 1, wherein the cocoa butter equivalent (CBE) is miscible in any proportion with cocoa butter.

38. A chocolate (CHO) according to claim 1, wherein the cocoa butter equivalent (CBE) is compatible with the physical properties of cocoa butter, wherein the physical properties consists of melting point and crystallization temperatures, melting rate, and need for tempering.

39. A chocolate (CHO) according to claim 1, wherein at least 50% by weight of the StOSt triglycerides in the cocoa butter equivalent (CBE) are obtained by transesterification.

40. A chocolate (CHO) according to claim 1,
wherein the content of StOSt triglycerides of the cocoa butter equivalent is between 18 and 80% by weight, and
wherein the content of SUU triglycerides of the cocoa butter equivalent is between 0.01 and 10% by weight.

41. A chocolate (CHO) comprising:
a cocoa butter equivalent (CBE);
sugar (SUG); and
one or more of the ingredients (ING) consisting of cocoa butter, cocoa mass, cocoa powder, milk fat, milk powder, vanilla, and lechitin,
wherein the cocoa butter equivalent (CBE) has a solid fat content given by 67-75% at 20° C., 60-66% at 25° C., 43-51% at 30° C., and 0-8% at 35° C.,
wherein the content of StOSt triglycerides of the cocoa butter equivalent (CBE) is at least 32% by weight, and
wherein the cocoa butter equivalent (CBE) is a mixture comprising a palm oil mid fraction (PMF) and a transesterified shea olein fraction (TSO).

42. (canceled)

43. A method for producing a chocolate (CHO), comprising a cocoa butter equivalent (CBE),
wherein the cocoa butter equivalent (CBE) has a solid fat content given by 62-81% at 20° C., 55-70% at 25° C., 34-56% at 30° C., and 0-12% at 35° C.,
wherein the content of StOSt triglycerides of the cocoa butter equivalent (CBE) is at least 18% by weight, wherein the StOSt triglycerides comprises StOSt tryglycerides obtained by transesterification,
wherein the content of SUU triglycerides of the cocoa butter equivalent (CBE) is less than 8% by weight, and
wherein the method comprises the steps of:
transesterifying a shea olein fraction (SO) to obtain a transesterified shea olein fraction (TSO);
mixing a palm oil mid fraction (PMF) and the transesterified shea olein (TSO) to obtain a cocoa butter equivalent (CBE); and
mixing the cocoa butter equivalent (CBE) with, sugar (SUG), and one or more of the ingredients (ING) consisting of cocoa butter, cocoa mass, cocoa powder, milk fat, milk powder, vanilla, and lechitin to obtain the chocolate (CHO).

44. (canceled)

45. A method of producing chocolate (CHO) comprising the step of incorporating a transesterified shea olein fraction (TSO) as an ingredient in the chocolate (CHO).

46. (canceled)

47. A chocolate (CHO) comprising:
a cocoa butter equivalent (CBE); and
sugar (SUG),
wherein the cocoa butter equivalent (CBE) comprises:
a stearin fraction; and
a palm oil mid fraction (PMF),
wherein the stearin fraction is obtained from a shea olein fraction (SO) by an enzymatic transesterification process (ETE).

48. A method of producing a chocolate (CHO), the method comprising the steps of:
obtaining a stearin fraction from a shea olein fraction (SO) by an enzymatic transesterification process (ETE);
mixing the stearin fraction with a palm oil mid fraction (PMF) to produce a cocoa butter equivalent (CBE); and
mixing the cocoa butter equivalent (CBE) with sugar (SUG) to obtain a chocolate (CHO).

49-50. (canceled)

51. A method of producing a chocolate (CHO) according to claim 1.
